(19) United States
(12) Patent Application Publication
(10) Pub. No.: US 2025/0391031 A1
(43) Pub. Date: Dec. 25, 2025

(54) METHOD AND SYSTEM FOR IMPROVING INSTANCE SEGMENTATION BASED ON ERROR PREDICTION

(71) Applicant: Gwangju Institute of Science and Technology, Gwangju (KR)

(72) Inventors: Kyoobin LEE, Gwangju (CN); Seung Hyeok BACK, Gwangju (CN); Kang Min KIM, Gwangju (CN); Sang Beom LEE, Gwangju (CN); Sung Ho SHIN, Gwangju (CN); Joo Soon LEE, Gwangju (CN); Je Mo MANEG, Gwangju (CN)

(73) Assignee: Gwangju Institute of Science and Technology, Gwangju (KR)

(21) Appl. No.: 19/175,795

(22) Filed: Apr. 10, 2025

(30) Foreign Application Priority Data
Jun. 24, 2024 (KR) 10-2024-0082163

(51) Int. Cl. G06T 7/12; G06T 7/194; G06V 10/771

(52) U.S. Cl. CPC G06T 7/12; G06T 7/194; G06V 10/771; G06V 2201/07

(57) ABSTRACT

A method of improving instance segmentation is provided, the method including: receiving at least one of an image or a depth map; recognizing one or more objects from at least one of the image or the depth map based on an instance segmentation model to generate an estimation for the instance segmentation; predicting errors within the estimation based on an error prediction model; and correcting the estimation based on the predicted errors to improve the instance segmentation to generate a mask corresponding to the one or more objects.

### CROSS REFERENCE TO RELATED APPLICATION

The present application claims priority to Korean Patent Application No. 10-2024-0082163, filed on Jun. 24, 2024, the entire contents of which is incorporated herein for all purposes by this reference.

### STATEMENT REGARDING PRIOR DISCLOSURES BY THE INVENTOR OR A JOINT INVENTOR

Prior disclosure related to the present application was made by inventors of the present application in journal paper entitled “INSTA-BEEER: Explicit Error Estimation and Refinement for Fast and Accurate Unseen Object Instance Segmentation” on Jun. 28, 2023. A copy of the journal paper is provided on a concurrently filed Information Disclosure Statement.

### BACKGROUND

### Field of the Invention

The present invention relates to a method and system for improving instance segmentation based on error prediction.

### DESCRIPTION OF GOVERNMENT-SPONSORED RESEARCH

The present invention was carried out with support from the national research and development project, with the unique project identification number being 1415184338 and the project number being 20008613. The project related to the present invention is supervised by the Ministry of Trade, Industry, and Energy, and managed by the Korea Evaluation Institute of Industrial Technology (KEIT). The research project is titled “Robot Industry Technology Development Project,” and the research project is named “Development of Shared Work Technology Based on Deep Reinforcement Learning for Intelligent Response to Unstructured Work Environments Such as Assembly Tasks.” The project executing institution is the Korea University Research and Business Foundation, and the research period is from Jan. 1, 2023, to Dec. 31, 2023.

### DESCRIPTION OF THE RELATED ART

Instance segmentation is a technology that involves segmenting individual objects in an image at the pixel level, which may be utilized in various ways in robotics application fields, leading to increasing interest in the field of computer vision.

In particular, instance segmentation may recognize all object instances in an image, and also recognize instances of objects that are occluded by other objects, thereby generating masks corresponding to different objects.

To this end, segmentation methods based on various techniques such as support vector machine (SVM) and ambiguity graph have been proposed for instance segmentation. More recently, with advancements in deep learning, instance segmentation models trained on large-scale synthetic data that are not restricted by specific categories have also been introduced.

These instance segmentation models learn the features of objects and distinguish the masks of foreground objects from the background in RGB-Depth images, effectively segmenting occluded objects, such as tabletop scenarios.

In addition, the instance segmentation models may generate masks for objects that lack training data based on unseen object instance segmentation, or the method has been proposed to improve the instance segmentation model by considering uncertainties in instance segmentation for objects, based on uncertainty-aware object instance segmentation.

### SUMMARY

The present invention relates to a system and method for improving instance segmentation based on error prediction, which facilitates image processing such as addition, deletion, merging, and segmentation of individual objects.

In addition, the present invention relates to a system and method for improving instance segmentation based on error prediction, which generates masks of uniform quality for each object regardless of the number of objects present in an image.

To solve the aforementioned objects, there is provided a method of improving instance segmentation using a system for improving instance segmentation, according to the present invention. The method may include: receiving at least one of an image or a depth map; recognizing one or more objects from at least one of the image or the depth map based on an instance segmentation model to generate an estimation for the instance segmentation; predicting errors within the estimation based on an error prediction model; and correcting the estimation based on the predicted errors to improve the instance segmentation to generate a mask corresponding to the one or more objects.

In addition, there is provided a system for improving instance segmentation, according to the present invention. The system may include: an input unit configured to receive at least one of an image or a depth map; and a control unit configured to recognize one or more objects from at least one of the image or the depth map based on an instance segmentation model to generate an estimation for the instance segmentation, in which the control unit may predict errors within the estimation based on an error prediction model, and correct the estimation based on the predicted errors to improve the instance segmentation to generate a mask corresponding to the one or more objects.

In addition, there is provided a program stored on a computer-readable recording medium, and executed by one or more processes in an electronic device, according to the present invention. In a method of improving instance segmentation using a system for improving instance segmentation, the program may include instructions to allow the program to perform: receiving at least one of an image or a depth map; recognizing one or more objects from at least one of the image or the depth map based on an instance segmentation model to generate an estimation for the instance segmentation; predicting errors within the estimation based on an error prediction model; and correcting the estimation based on the predicted errors to improve the instance segmentation to generate a mask corresponding to the one or more objects.

According to various embodiments of the present invention, the method and system for improving instance segmentation based on error prediction may recognize one or more objects from an image and generate masks corresponding to individual objects, thereby facilitating image processing such as addition, deletion, merging, and segmentation for individual objects.

In addition, according to various embodiments of the present invention, the method and system for improving instance segmentation based on error prediction can improve the mask of individual objects recognized from the image through foreground, center, and offset analysis, thereby generating masks of uniform quality for each object regardless of the number of objects present in the image.

### BRIEF DESCRIPTION OF THE DRAWINGS

FIG. 1 illustrates an embodiment for improving instance segmentation.

FIG. 2 illustrates an embodiment of an error for an estimation.

FIG. 3 illustrates an embodiment of a system for improving instance segmentation according to the present invention.

FIG. 4 illustrates an embodiment of a foreground map, a center map, and an offset map for an estimation.

FIG. 5 illustrates a system for improving instance segmentation according to the present invention.

FIG. 6 is a flowchart illustrating the method of improving instance segmentation according to the present invention.

FIG. 7 illustrates an embodiment combining each of an image and a depth map with an estimation.

FIG. 8 illustrates an embodiment for generating a feature map for an estimation.

FIG. 9 illustrates an embodiment for estimating an error for an estimation.

FIG. 10 illustrates an embodiment for correcting an error for an estimation.

FIG. 11 is a block diagram illustrating the structure of a computing device that performs a method of improving instance segmentation according to the present invention.

### DETAILED DESCRIPTION OF EMBODIMENTS

Hereinafter, exemplary embodiments disclosed in the present specification will be described in detail with reference to the accompanying drawings. The same or similar constituent elements are assigned with the same reference numerals regardless of reference numerals, and the repetitive description thereof will be omitted. The suffixes “module”, “unit”, “part”, and “portion” used to describe constituent elements in the following description are used together or interchangeably in order to facilitate the description, but the suffixes themselves do not have distinguishable meanings or functions. In addition, in the description of the exemplary embodiment disclosed in the present specification, the specific descriptions of publicly known related technologies will be omitted when it is determined that the specific descriptions may obscure the subject matter of the exemplary embodiment disclosed in the present specification. In addition, it should be interpreted that the accompanying drawings are provided only to allow those skilled in the art to easily understand the embodiments disclosed in the present specification, and the technical spirit disclosed in the present specification is not limited by the accompanying drawings, and includes all alterations, equivalents, and alternatives that are included in the spirit and the technical scope of the present invention.

The terms including ordinal numbers such as “first,” “second,” and the like may be used to describe various constituent elements, but the constituent elements are not limited by the terms. These terms are used only to distinguish one constituent element from another constituent element.

When one constituent element is described as being “coupled” or “connected” to another constituent element, it should be understood that one constituent element can be coupled or connected directly to another constituent element, and an intervening constituent element can also be present between the constituent elements. When one constituent element is described as being “coupled directly to” or “connected directly to” another constituent element, it should be understood that no intervening constituent element exists between the constituent elements.

Singular expressions include plural expressions unless clearly described as different meanings in the context.

In the present application, it should be understood that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance.

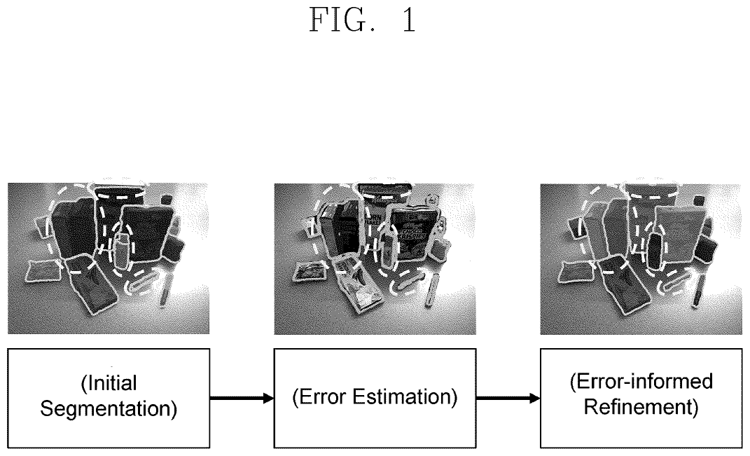

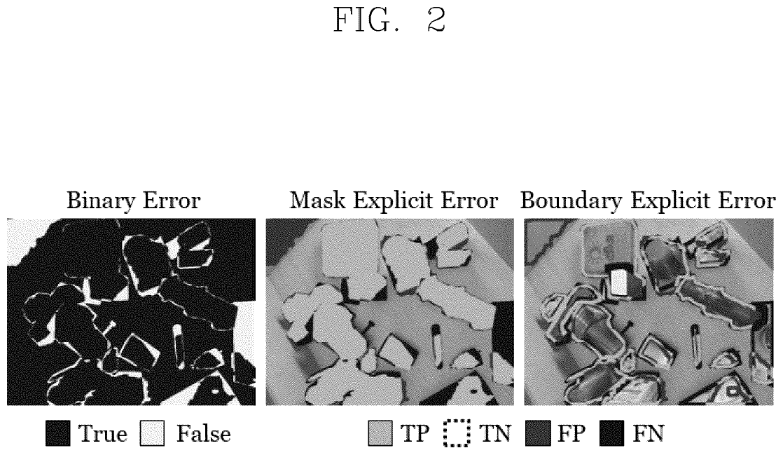

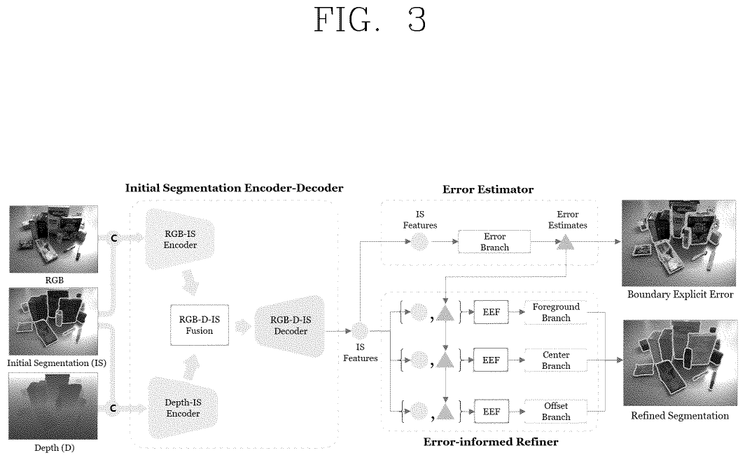

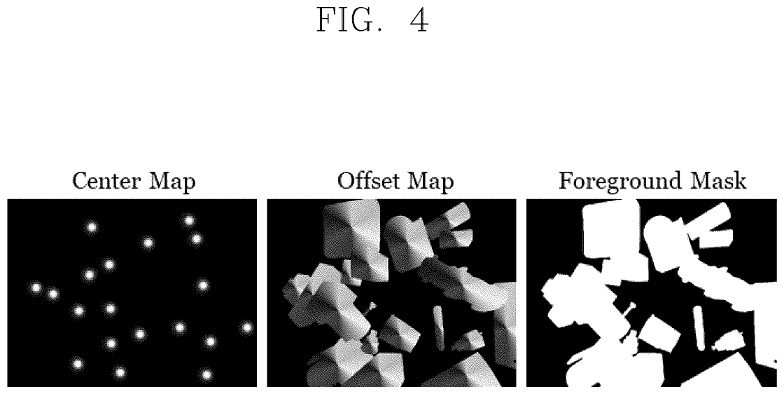

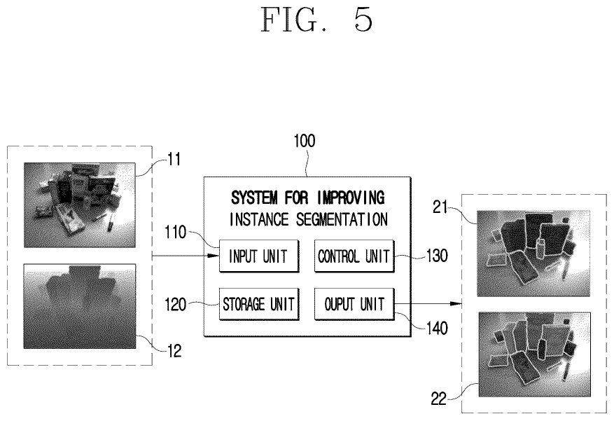

FIG. 1 illustrates an embodiment for improving instance segmentation. FIG. 2 illustrates an embodiment of an error for an estimation. FIG. 3 illustrates an embodiment of a system for improving instance segmentation according to the present invention. FIG. 4 illustrates an embodiment of a foreground map, a center map, and an offset map for an estimation. FIG. 5 illustrates a system for improving instance segmentation according to the present invention.

With reference to FIG. 1, a system 100 for improving instance segmentation according to the present invention may recognize one or more objects from an image to generate an estimation (or initial mask) (e.g., initial segmentation), analyze the estimation previously generated based on the image and a depth map corresponding to the image to predict an error for the estimation (e.g., error estimation), and generate an improved mask (or final mask) based on the predicted error (e.g., error-informed refinement).

Here, the estimation may be a mask generated from the image through an instance segmentation model. Accordingly, the system 100 for improving instance segmentation may generate a final mask with improved instance segmentation (or improved instance segmentation results) by improving the error of the estimation (or initial mask) generated through the instance segmentation model.

The mask (e.g., estimation and final mask) may be a result of recognizing an object from an image, and may be formed by grouping (or specifying) a plurality of pixels corresponding to the object among a plurality of pixels belonging to the image.

Accordingly, as illustrated in FIG. 2, errors related to the mask may include a binary error, a mask explicit error, and a boundary explicit error.

In this case, the binary error may indicate whether a mask region is true or false. That is, the binary error may include whether there is an error in the mask region or in the region outside the mask.

In addition, the mask explicit error may indicate an explicit mask explicit error for the plurality of pixels belonging to the mask (e.g., true positive (TP), false positive (FP), false negative (FN), and true negative (TN)). That is, the mask explicit error may include information on whether the mask region is correctly estimated or fails, as well as whether the region outside the mask is correctly estimated or fails.

In addition, the boundary explicit error may indicate an explicit boundary explicit error for the plurality of pixels corresponding to the boundary of the mask (e.g., true positive, false positive, false negative, and true negative). That is, the boundary explicit error may include information on whether the pixels corresponding to the boundary of the mask are correctly estimated or fail, as well as whether the pixels not corresponding to the mask boundary are correctly estimated or fail.

In addition, the depth map may represent information on the depth of each object appearing in the image and may indicate a distance between each object from a camera that captured the image.

Meanwhile, as illustrated in FIG. 3, the system 100 for improving instance segmentation may be implemented in a form where a plurality of models (or modules) that perform different operations are integrally connected to improve the estimation generated from the image. During the process of implementing such a plurality of models, a training process using training images (or training masks) and ground truth estimation (or ground truth masks) may be performed.

In an embodiment, the system 100 for improving instance segmentation may generate a feature map for the estimation through an initial segmentation encoder-decoder, estimate errors for the estimation based on the feature map of the estimation through an error estimator, and predict a foreground map, center map, and offset map for the mask (or final mask) based on the feature map and errors of the estimation through an error-informed refiner.

In this case, with reference to FIG. 4, the foreground map (or mask) may represent the entire mask region recognized from the image. That is, when the image includes a single object, the foreground map may represent the mask region for the corresponding object, and when the image includes a plurality of objects, the foreground map may represent the entire mask region obtained by merging the mask regions for each of the plurality of objects.

In addition, the center map may represent the probability of each pixel being a center point of the mask. That is, when the image includes a single object, the center map may represent the probability that each pixel in the image is a central pixel of the corresponding object. When the image includes a plurality of objects, the center map may represent the probability that each pixel in the image is a central pixel of each of the plurality of objects.

In addition, the offset map may represent a distance by which each pixel is offset from the center point of the mask. That is, when the image includes a single object, the offset map may represent a distance from each pixel in the image to a center point of the corresponding object. When the image includes a plurality of objects, the offset map may represent a distance from each pixel in the image to the nearest center point.

Meanwhile, with reference to FIG. 5, the system 100 for improving instance segmentation according to the present invention may include an input unit 110, a storage unit 120, a control unit 130, and an output unit 140.

The input unit 110 may receive information necessary for the operation of the system 100 for improving instance segmentation according to the present invention as input. To this end, the input unit 110 may be connected to a separate input device, server, or external storage device via a wireless or wired network.

Accordingly, the input unit 110 may receive at least one of an image 11 or a depth map 12 from a separate input device, server, external storage device, or the like.

In addition, the storage unit 120 may store instructions and information necessary for the operation of the system 100 for improving instance segmentation according to the present invention. For example, the storage unit 120 may store at least one of the image 11 or the depth map 12 that are input through the input unit 110.

In addition, the storage unit 120 may store an estimation 21 generated from the image 11 by the control unit 130, and may store a plurality of models implemented to generate the mask (e.g., estimation 21 or final mask 22). Further, the storage unit 120 may store the final mask 22 generated by the control unit 130, as well as various data generated during the process of generating the final mask 22.

The control unit 130 may control the overall operation of the system 100 for improving instance segmentation according to the present invention. That is, the control unit 130 may generate the estimation 21 from at least one of the image 11 or the depth map 12 and generate the final mask 22 with the improved estimation 21 based on a plurality of pre-implemented models.

The output unit 140 may output the information generated by the operation of the system 100 for improving instance segmentation according to the present invention. To this end, the output unit 140 may be connected to a separate visual output device, server, external storage device, or the like via a wireless or wired network.

Accordingly, the output unit 140 may output the image 11, depth map 12, estimation 21, and final mask 22, and the like through a separate output device, server, external storage device, or the like, so that the user may visually identify them. Depending on the embodiment, the output unit may also transmit the image 11, depth map 12, estimation 21, and final mask 22 to other devices.

With the configuration of the system 100 for improving instance segmentation as described above, the following will provide a more detailed description of a method of improving instance segmentation.

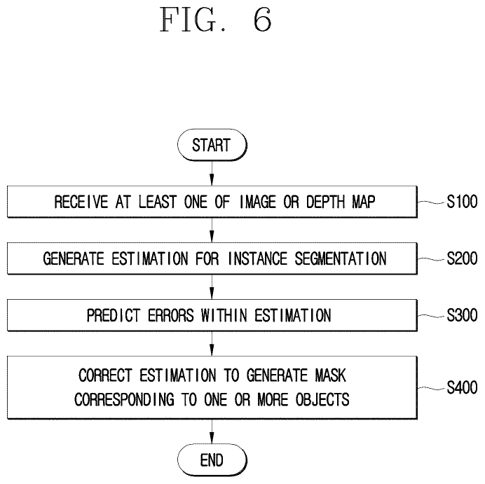

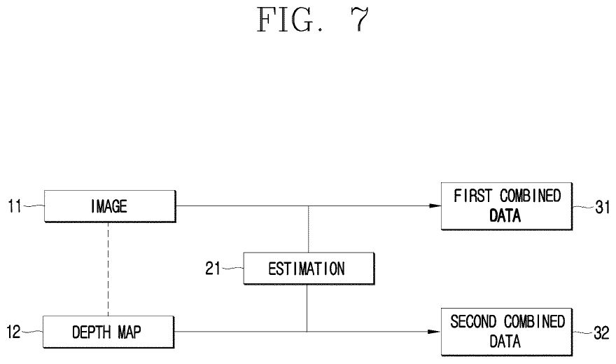

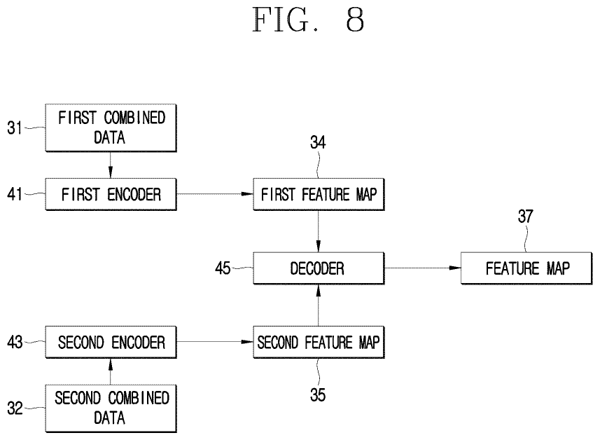

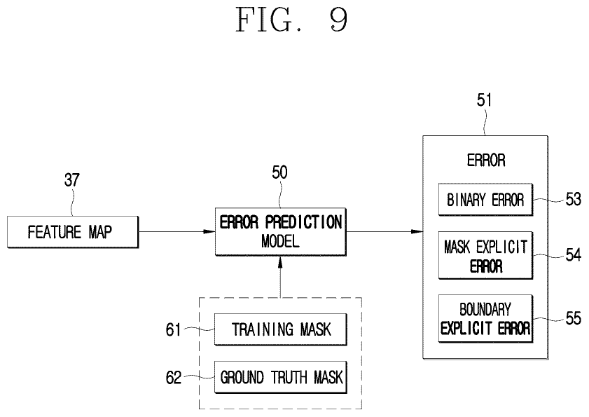

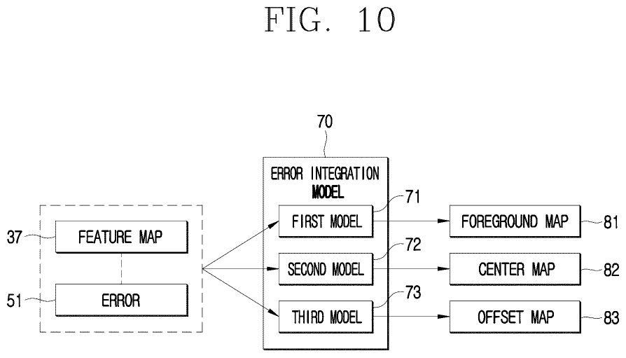

FIG. 6 is a flowchart illustrating the method of improving instance segmentation according to the present invention. FIG. 7 illustrates an embodiment combining each of an image and a depth map with an estimation. FIG. 8 illustrates an embodiment for generating a feature map for an estimation. FIG. 9 illustrates an embodiment for estimating an error for an estimation. FIG. 10 illustrates an embodiment for correcting an error for an estimation.

With reference to FIG. 6, the system 100 for improving instance segmentation according to the present invention may receive at least one of an image or a depth map (S100), and recognize one or more objects from at least one of the image or depth map based on a pre-trained instance segmentation model to generate an estimation (or initial mask) for the instance segmentation (S200). In this case, when the depth map is received along with the image, the depth map may correspond to the image.

Specifically, the system 100 for improving instance segmentation may input the previously received image into the instance segmentation model pre-trained based on a training image and a ground truth mask, which is label data for the training image, to acquire an estimation.

For example, the instance segmentation model may be trained using training images and ground truth estimations (or ground truth masks), when a predetermined image is input, to generate an estimation (or mask) for instance segmentation for one or more objects belonging to the corresponding image.

Such an instance segmentation model may be implemented, depending on the embodiment, to perform a predetermined preprocessing on the image or to perform a predetermined postprocessing on the estimation output from the model. Various types of models for generating estimations for one or more objects from an image may also be utilized.

That is, depending on the embodiment, various technologies may be utilized for the instance segmentation model, such as Panoptic-DeepLab, Mask R-CNN, DeepLab v3+, and U-Net.

Accordingly, the system 100 for improving instance segmentation may input the previously received image into the pre-trained instance segmentation model to generate an estimation for one or more recognizable objects in the image.

In this case, the system 100 for improving instance segmentation may refer to the depth map corresponding to the image during the process of generating the estimation from the image. To this end, the system 100 for improving instance segmentation may receive a depth map corresponding to the image along with the image, or may estimate a depth map corresponding to the image from the image itself.

That is, the system 100 for improving instance segmentation may input the depth map along with the image into the instance segmentation model to generate an estimation corresponding to both the image and the depth map, or may correct the mask generated from the image based on the depth map to generate an estimation.

Meanwhile, in an embodiment, the estimation may also include an initial center map (or first center map) and an initial offset map (or first offset map). That is, the estimation may be data in which the initial center map and the initial offset map are combined in different channels.

Here, the initial center map may represent the probability that each pixel is a center point of the estimation, while the initial offset map may represent a distance by which each pixel is offset from the center point of the estimation.

In this case, when estimations are generated for a plurality of different objects from the image, the initial center map may include the probability that each pixel is a center point for the estimation corresponding each pixel.

In addition, when estimations are generated for a plurality of different objects from the image, the initial offset map may represent either a distance from each pixel to the nearest center point or a distance from each pixel to the center point of the estimation corresponding to each pixel.

As another example, the system 100 for improving instance segmentation may receive a predetermined depth map. In this case, the system 100 for improving instance segmentation may estimate the color of the image based on the depth map.

That is, the system 100 for improving instance segmentation may determine a pixel color of the image based on a depth value of a pixel according to the depth map and generate an image corresponding to the depth map by performing interpolation according to adjacent pixels.

Therefore, the system 100 for improving instance segmentation may input the image into the pre-trained instance segmentation model to generate an estimation corresponding to the depth map (or image).

In this case, depending on the embodiment, the system 100 for improving instance segmentation may input the depth map into the pre-trained instance segmentation model to generate an estimation corresponding to the depth map (or image), or may input the image along with the depth map into the pre-trained instance segmentation model to generate an estimation.

As another example, the system 100 for improving instance segmentation may input the previously received depth map into the instance segmentation model pre-trained based on a training depth map and a ground truth mask, which is label data for the training depth map, to acquire an estimation.

In this case, the instance segmentation model may be trained to generate an estimation (or mask) for instance segmentation for one or more objects belonging to a predetermined depth map when the corresponding depth map is input.

The system 100 for improving instance segmentation according to the present invention may predict errors within the estimation based on an error prediction model (S300).

In this case, the system 100 for improving instance segmentation may input the feature map of the estimation into the error prediction model trained based on a training mask and a ground truth mask, which is label data for the training mask, to predict errors for the estimation.

In this regard, the system 100 for improving instance segmentation may estimate a feature map for the estimation using at least one of the image or the depth map along with the estimation.

Specifically, the system 100 for improving instance segmentation may combine the estimation with at least one of the image or the depth map to generate at least one of first combined data, in which the estimation is combined with the image, or second combined data, in which the estimation is combined with the depth map.

With reference to FIG. 7, for example, the system 100 for improving instance segmentation may combine the image 11 and depth map 12, respectively, with the estimation 21 generated based on at least one of the image 11 or depth map 12, to generate at least one of first combined data 31 or second combined data 32.

In this case, the first combined data 31 may be combining the image 11 with the estimation 21, while the second combined data 32 may be combining the depth map 12 with the estimation 21.

In addition, the system 100 for improving instance segmentation may generate the first combined data 31 in which the image 11 is combined with the estimation 21 by adding a channel corresponding to the estimation 21 to the image 11 that includes one or more color channels (e.g., RGB or CMYK). Likewise, the system may generate the second combined data 32 in which the depth map 12 is combined with the estimation 21 by adding a channel corresponding to the estimation 21 to the depth map 12 that includes a depth channel.

As another example, the system 100 for improving instance segmentation may generate a first estimation based on the image and generate a second estimation based on the depth map. In this case, the system 100 for improving instance segmentation may generate the first combined data by combining the image with the first estimation generated based on the image, and may generate the second combined data by combining the depth map with the second estimation generated based on the depth map.

Further, the system 100 for improving instance segmentation may estimate at least one of a first feature map corresponding to the first combined data or a second feature map corresponding to the second combined data from at least one of the first combined data or the second combined data. Using at least one of the first feature map or the second feature map, the system may generate a feature map for the estimation.

In this case, when both the first feature map and the second feature map are estimated together, the system 100 for improving instance segmentation may combine the first feature map and the second feature map to generate the feature map for the estimation.

With reference to FIG. 8, for example, the system 100 for improving instance segmentation may input the first combined data 31 and the second combined data 32 into a feature combining model pre-implemented in an encoder-decoder manner, to generate a feature map for the estimation.

That is, the system 100 for improving instance segmentation may input the first combined data 31 and the second combined data 32 into the encoder of the feature combining model, respectively, to generate a first feature map 34 corresponding to the first combined data 31 and a second feature map 35 corresponding to the second combined data 32.

In this case, the feature combining model may include a first encoder 41 provided to receive the first combined data 31 and generate the first feature map 34, and a second encoder 43 provided to receive the second combined data 32 and generate the second feature map 35.

Each of the first encoder 41 and the second encoder 43 may be implemented to perform spatial resolution compression on each of the first combined data 31 and the second combined data 32 to generate the feature maps 34 and 35 corresponding to each data.

In addition, the feature combining model may further include a decoder 45, which receives the output data from each of the first encoder 41 and the second encoder 43 and generates a feature map for the estimation corresponding to each of the first combined data 31 and the second combined data 32.

In this case, the decoder 45 may be implemented in conjunction with the first encoder 41 and the second encoder 43 such that, when the first feature map 34 and the second feature map 35 are generated together, the decoder 45 combines the first feature map 34 and the second feature map 35.

That is, the feature combining model may input each of the first feature map 34 and the second feature map 35 into the decoder 45, allowing the decoder to generate a feature map 37 for the estimation, which is obtained by combining the first feature map 34 and the second feature map 35.

In this case, the decoder 45 may be implemented to generate the feature map 37 for the estimation by performing a convolution operation on the first feature map 34 and the second feature map 35.

In this regard, the decoder 45 may include a plurality of convolution layers, and each convolution layer may be provided to receive not only the data output from the preceding convolution layer but also the data output from the encoder corresponding each convolution layer (e.g., first feature map 34 and second feature map 35) as inputs.

In an embodiment, the feature combining model may include two separate ResNet-50 backbones pre-trained on ImageNet, where one of the two separate backbones is implemented to receive the first combined data 31 as input, and the other is implemented to receive the second combined data 32 as input.

In this case, each backbone may include a plurality of encoders and decoders, where each encoder is implemented to progressively compress the spatial resolution of the first combined data and the second combined data, respectively. Each decoder may include two or more 3×3 convolution layers and one 1×1 convolution layer, and be implemented to generate a feature map for the estimation.

In addition, the feature combining model may be provided with a spatial pyramid pooling layer connected to an output stage of the decoder, as well as a depthwise separable convolution layer capable of performing a 5×5 convolution, both of which are implemented to upsample the data output from the decoder.

With the configurations as described above, the system 100 for improving instance segmentation may input the feature map of the estimation into the error prediction model trained based on a training mask and a ground truth mask, which is label data for the training mask, to predict errors for the estimation.

With reference to FIG. 9, for example, an error prediction model 50 may be trained based on a training mask 61 and a ground truth mask 62 so that, when the feature map 37 for the estimation is input, the error prediction model 50 predicts an error 51 for the estimation.

In this case, the error prediction model 50 may use the feature map corresponding to the training mask 61 as a training feature map and use the feature map corresponding to the ground truth mask 62 as a ground truth feature map.

Accordingly, the error prediction model 50 may be trained based on the training feature map and the ground truth feature map so that, when the feature map 37 is input, a corrected feature map is output in consideration of the error 51 of the input feature map 37.

Therefore, the system 100 for improving instance segmentation may input the feature map 37 for the previously generated estimation into the error prediction model 50 to acquire a corrected feature map where the error 51 of the feature map 37 has been corrected.

In this case, the system 100 for improving instance segmentation may generate the error 51 based on a difference between the feature map 37 for the estimation and the feature map acquired from the error prediction model 50, or may specify the feature map acquired from the error prediction model 50 as the error 51.

Alternatively, the system 100 for improving instance segmentation may estimate, as the error 51, the probability that an error is to be occurred in each pixel, for each of the plurality of pixels corresponding to the estimation. In this case, the error 51 may include a binary error 53, a mask explicit error 54, and a boundary explicit error 55.

As another example, the error prediction model may use the feature map corresponding to a training estimation as a training feature map, and use a difference between the feature map corresponding to the training estimation and the feature map corresponding to the ground truth mask as an ground truth error.

In this case, the error prediction model may be trained based on the training feature map and the ground truth error so that, when a feature map is input, the error corresponding to the input feature map is output.

Accordingly, the system 100 for improving instance segmentation may input the feature map for the previously generated estimation into the error prediction model to acquire the error corresponding to the feature map.

With reference back to FIG. 6, the system 100 for improving instance segmentation according to the present invention may correct the estimation based on the previously predicted error to improve instance segmentation and generate a mask corresponding to one or more objects (S400).

Specifically, the system 100 for improving instance segmentation may correct the errors for each of the foreground map, center map, and offset map of the estimation based on the previously predicted error to generate a mask (or final mask) corresponding to one or more objects.

To this end, the system 100 for improving instance segmentation may combine the previously predicted error with the feature map for the estimation to generate an error-combined feature map.

For example, the system 100 for improving instance segmentation may combine the feature map for the estimation with the previously predicted error as different channels. That is, the number of channels in the error-combined feature map may be the sum of the number of channels in the feature map and the number of channels in the error.

In this case, the error may be a corrected feature map in which the error has been corrected from the feature map for the estimation based on the error prediction model, or, depending on the embodiment, may also represent an error corresponding to the feature map for the estimation.

Further, the system 100 for improving instance segmentation may generate, based on a pre-trained error integration model, a final foreground map with the corrected error for the foreground map (or initial foreground map) of the estimation, a final center map with the corrected error for the center map (or initial center map), and a final offset map with the corrected error for the offset map (or initial offset map), respectively, from the error-combined feature map.

In this case, the foreground map may represent the entire mask region for one or more objects belonging to the image. In addition, the center map may represent the probability that each pixel is the center of the mask for each of one or more objects, while the offset map may represent the nearest distance from each pixel to the central pixel of the mask for each of one or more objects.

With reference to FIG. 10, for example, an error integration model 70 may include a first model 71 trained to estimate a foreground map 81 (or final foreground map), a second model 72 trained to estimate a center map 82 (or final center map), and a third model 73 trained to estimate an offset map 83 (or final offset map).

In this case, each of the first model 71, second model 72, and third model 73 may be implemented in the same form and trained based on different data during the training process.

That is, the first model 71 may be trained to estimate the foreground map 81 of the ground truth mask based on the training mask and the ground truth mask, the second model 72 may be trained to estimate the center map 82 of the ground truth mask based on the training mask and the ground truth mask, and the third model 73 may be trained to estimate the offset map 83 of the ground truth mask based on the training mask and the ground truth mask.

Therefore, the system 100 for improving instance segmentation may input the feature map 37 combined with the error 51 into the first model 71 to acquire the foreground map 81 for one or more objects belonging to the image as the final foreground map. Likewise, the system may input the feature map 37 combined with the error 51 into the second model 72 to acquire the center map 82 for one or more objects belonging to the image as the final center map, and input the feature map 37 combined with the error 51 into the third model 73 to acquire the offset map 83 for one or more objects belonging to the image as the final offset map.

Further, the system 100 for improving instance segmentation may generate an improved final mask from the estimation using the previously generated final foreground map, final center map, and final offset map.

For example, the system 100 for improving instance segmentation may generate a final mask by grouping a plurality of pixels according to a distance to the center for each pixel indicated by the final offset map with respect to the final center map, for the mask region indicated by the final foreground map.

That is, the system 100 for improving instance segmentation may generate one or more final masks for the mask region indicated by the final foreground map, with respect to the central pixel according to the final center map. In this case, each final mask may include a plurality of pixels grouped to the central pixel nearest to each pixel, based on the final offset map.

With the configurations as described above, the system 100 for improving instance segmentation according to the present invention may recognize one or more objects from an image and generate masks corresponding to individual objects, thereby facilitating image processing such as addition, deletion, merging, and segmentation for individual objects.

In addition, the system 100 for improving instance segmentation according to the present invention may improve the mask of individual objects recognized from the image through foreground, center, and offset analysis, thereby generating masks of uniform quality for each object regardless of the number of objects present in the image.

Further, the system 100 for improving instance segmentation according to the present invention may be configured of a computing device capable of performing at least one function related to the aforementioned method of improving instance segmentation.

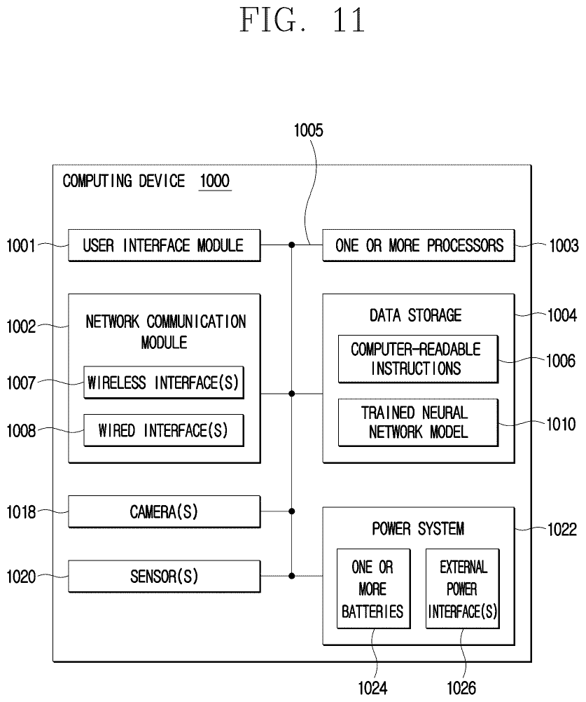

FIG. 11 is a block diagram illustrating the structure of a computing device that performs a method of improving instance segmentation according to the present invention.

The computing device 1000 may include a user interface module 1001, a network communication module 1002, one or more processors 1003, data storage 1004, one or more cameras 1018, one or more sensors 1020, and a power system 1022, all of which may be interconnected via a system bus, network, or other connection mechanism 1005.

The user interface module 1001 may be operable to transmit data to and/or receive data from external user input/output devices.

For example, in the present invention, receiving, by the system 100 for improving instance segmentation, at least of the image or depth map may performed by an external input using the user interface module. In this case, the user interface module 1001 may include a touchscreen, computer mouse, keyboard, keypad, touchpad, trackball, joystick, voice recognition module, or other similar devices.

In addition, the user interface module 1001 may also be configured to provide output to one or more user display devices, such as a cathode ray tube (CRT), liquid crystal display (LCD), light-emitting diode (LED), display using digital light processing (DLP) technology, or a printer.

The user interface module 1001 may also be configured to generate audible output using devices such as speakers, speaker jacks, audio output ports, audio output devices, earphones, and/or other similar devices.

The user interface module 1001 may further configured with one or more haptic devices capable of generating tactile output, such as vibration and/or other forms of output, detectable by touch and/or physical contact with the computing device 1000.

The network communication module 1002 may include one or more devices that provide one or more wireless interfaces 1007 and/or one or more wired interfaces 1008, which can be configured to communicate over a network.

In addition, the network communication module 1002 may be configured to provide secure and/or authenticated communication that is reliable.

The one or more processors 1003 may include one or more general-purpose processors and/or one or more special-purpose processors (e.g., digital signal processors, tensor processing units (TPUs), graphics processing units (GPUs), neural processing units (NPUs), application-specific integrated circuits (ASICs), or application-specific semiconductors, etc.). The one or more processors 1003 may be configured to execute computer-readable instructions 1006 included in the data storage 1004 and/or other commands described in the present specification.

As such an example, the algorithms utilized in the process of improving instance segmentation described in the present specification may be executed on a neural processing unit (NPU), thereby enhancing efficiency by performing data calculation processing with high speed and low power consumption.

The data storage 1004 may include one or more non-transitory computer-readable storage media that are readable and/or accessible by at least one of the one or more processors 1003.

The one or more computer-readable storage media may include volatile and/or non-volatile storage constituent elements, such as optical, magnetic, organic, or other memory or disk storage devices. In some examples, the data storage 1004 may be implemented using a single physical device (e.g., one optical, magnetic, organic, or other memory or disk storage device), whereas in other examples, the data storage 1004 may be implemented using two or more physical devices.

The data storage 1004 may include computer-readable instructions 1006 as well as additional data. The data storage 1004 may include storage necessary to perform at least part of the methods, scenarios, and technologies described in the present specification and/or at least part of the functions of the devices and networks.

In some examples, the data storage 1004 may include a storage for the trained neural network model 1010 described in the present invention (e.g., instance segmentation model, feature combining model, and error prediction model).

Meanwhile, the computing device 1000 may include one or more cameras 1018, one or more sensors 1020, and/or a power system 1022.

The camera(s) 1018 may capture light and/or electromagnetic radiation emitted as visible light, infrared radiation, ultraviolet light, and/or one or more other frequencies of light. The sensor 1020 may be configured to measure conditions within the computing device 1000 and/or conditions in the environment of the computing device 1000 and provide data regarding these conditions. The power system 1022 may include one or more batteries 1024 and/or one or more external power interfaces 1026 to provide power to the computing device 1000.

Meanwhile, the above description explains the implementation of the system 100 for improving instance segmentation 100 of the present invention as a computing device, but the present invention is not limited thereto. For example, the functionality of the neural network and/or computing device may be distributed among a plurality of computing clusters.

Further, the present invention described above may be implemented as a program executed by one or more processes in an electronic device and stored on a computer-readable recording medium.

Therefore, the present invention may be implemented as computer-readable code or instructions on a medium in which the program is recorded. That is, the various control methods according to the present invention may be provided in the form of a program, either in an integrated or individual manner.

Meanwhile, the computer-readable medium includes all kinds of storage devices for storing data readable by a computer system. Examples of computer-readable media include hard disk drives (HDDs), solid state disks (SSDs), silicon disk drives (SDDs), ROMs, RAMs, CD-ROMs, magnetic tapes, floppy discs, and optical data storage devices.

Further, the computer-readable medium may be a server or cloud storage that includes storage and that the electronic device is accessible through communication. In this case, the computer may download the program according to the present invention from the server or cloud storage, through wired or wireless communication.

Further, in the present invention, the computer described above is an electronic device equipped with a processor, that is, a central processing unit (CPU), and is not particularly limited to any type.

Meanwhile, it should be appreciated that the detailed description is interpreted as being illustrative in every sense, not restrictive. The scope of the present invention should be determined on the basis of the reasonable interpretation of the appended claims, and all of the modifications within the equivalent scope of the present invention belong to the scope of the present invention.

What is claimed is:

1. A method of improving instance segmentation using a system for improving instance segmentation, the method comprising:
receiving at least one of an image or a depth map;
recognizing one or more objects from at least one of the image or the depth map based on an instance segmentation model to generate an estimation for the instance segmentation;
predicting errors within the estimation based on an error prediction model; and
correcting the estimation based on the predicted errors to improve the instance segmentation to generate a mask corresponding to the one or more objects.

2. The method of claim 1, wherein the generating of the mask includes correcting errors for each of a foreground map, a center map, and an offset map of the estimation based on the predicted errors.

3. The method of claim 2, wherein the correcting of the errors includes:
estimating a feature map for the estimation;
combining the predicted errors with the estimated feature map to generate an error-combined feature map; and
generating, based on an error integration model, a final foreground map with corrected errors for the foreground map of the estimation, a final center map with corrected errors for the center map of the estimation, and a final offset map with corrected errors for the offset map of the estimation, from the error-combined feature map, respectively.

4. The method of claim 3, wherein the error integration model includes:
a first model trained to estimate the final foreground map;
a second model trained to estimate the final center map; and
a third model trained to estimate the final offset map.

5. The method of claim 3, wherein the generating of the mask further includes:
generating an error-improved mask from the estimation using the final foreground map, the final center map, and the final offset map.

6. The method of claim 1, wherein the predicting of the errors includes:
estimating a feature map for the estimation using at least one of the image or the depth map along with the estimation; and
predicting the errors for the estimation using the estimated feature map based on the error prediction model.

7. The method of claim 6, wherein the estimating of the feature map includes:
combining the estimation with at least one of the image or the depth map to generate at least one of first combined data, where the estimation is combined with the image, or second combined data, where the estimation is combined with the depth map; and
generating a feature map for the estimation based on at least one of the first combined data or the second combined data.

8. The method of claim 7, wherein the generating of the feature map for the estimation based on at least one of the first combined data or the second combined data includes:
estimating at least one of a first feature map corresponding to the first combined data or a second feature map corresponding to the second combined data from at least one of the first combined data or the second combined data; and
generating a feature map for the estimation using at least one of the first feature map or the second feature map.

9. A system for improving instance segmentation comprising:
an input unit configured to receive at least one of an image or a depth map; and
a control unit configured to recognize one or more objects from at least one of the image or the depth map based on an instance segmentation model to generate an estimation for the instance segmentation,
wherein the control unit is configured to:
predict errors within the estimation based on an error prediction model; and
correct the estimation based on the predicted errors to improve the instance segmentation to generate a mask corresponding to the one or more objects.

10. A program stored on a computer-readable recording medium, and executed by one or more processes in an electronic device, in a method of improving instance segmentation using a system for improving instance segmentation, the program comprising instructions to allow the program to perform:
receiving at least one of an image or a depth map;
recognizing one or more objects from at least one of the image or the depth map based on an instance segmentation model to generate an estimation for the instance segmentation;
predicting errors within the estimation based on an error prediction model; and
correcting the estimation based on the predicted errors to improve the instance segmentation to generate a mask corresponding to the one or more objects.
